(19) United States
(12) Patent Application Publication
(10) Pub. No.: US 2026/0351557 A1
(43) Pub. Date: Nov. 5, 2026

(54) METHOD OF PRODUCING ELECTRODE MIXED MATERIAL SLURRY AND METHOD OF PRODUCING ELECTRODE ACTIVE MATERIAL LAYER

(71) Applicant: TOYOTA JIDOSHA KABUSHIKI KAISHA, Toyota-shi (JP)

(72) Inventor: Ryosuke FURUYA, Gotemba-shi (JP)

(73) Assignee: TOYOTA JIDOSHA KABUSHIKI KAISHA, Toyota-shi (JP)

(21) Appl. No.: 19/644,649

(22) Filed: Apr. 10, 2026

(30) Foreign Application Priority Data
May 1, 2025 (JP) 2025-076272

(51) Int. Cl. H01M 4/139; H01M 4/02; H01M 4/04; H01M 4/62

(52) U.S. Cl. CPC H01M 4/139; H01M 4/0404; H01M 4/62; H01M 2004/021

(57) ABSTRACT

A method of producing an electrode mixed material slurry according to the present disclosure includes a step of mixing solid electrolyte particles, a dispersant, and a solvent to prepare a solid electrolyte slurry, and a step of mixing porous electrode active material particles with the solid electrolyte slurry. In the method, Relational Expressions (1) a specific surface area of the porous electrode active material particles>a specific surface area of the solid electrolyte particles; and (2) an average particle diameter of the porous electrode active material particles>an average particle diameter of the solid electrolyte particles, are satisfied. A method of producing an electrode active material layer according to the present disclosure includes a step of producing the electrode mixed material slurry by the method, and a step of applying the electrode mixed material slurry to a base material and drying and removing the solvent.

### CROSS-REFERENCE TO RELATED APPLICATION

This application claims priority to Japanese Patent Application No. 2025-076272 filed on May 1, 2025. The disclosure of the above-identified application, including the specification, drawings, and claims, is incorporated by reference herein in its entirety.

### BACKGROUND

### 1. Technical Field

The present disclosure relates to a method of producing an electrode mixed material slurry and a method of producing an electrode active material layer.

### 2. Description of Related Art

As disclosed in Japanese Unexamined Patent Application Publication No. 2017-054720 A, a negative electrode (negative electrode active material layer) for an all-solid state battery including a solid electrolyte and a negative electrode active material is known.

### SUMMARY

The ion conductivity of the electrode active material layer including the solid electrolyte and the electrode active material has room for improvement.

An object of the present disclosure is to provide a method of producing an electrode mixed material slurry capable of improving the ion conductivity of an electrode active material layer and a method of producing an electrode active material layer including producing an electrode mixed material slurry by such a method.

The present inventors have found that the above-described object can be achieved by the following means.

### Aspect 1

A method of producing an electrode mixed material slurry, the method comprising the following steps: a step of mixing solid electrolyte particles, a dispersant, and a solvent to prepare a solid electrolyte slurry; and a step of mixing porous electrode active material particles with the solid electrolyte slurry, in which the following relational expressions (1) and (2) are satisfied: (1) a specific surface area of the porous electrode active material particles>a specific surface area of the solid electrolyte particles; and (2) an average particle diameter of the porous electrode active material particles>an average particle diameter of the solid electrolyte particles.

### Aspect 2

The method according to Aspect 1, in which the porous electrode active material particles are electrode active material composite particles, and the electrode active material composite particles are secondary particles made of a plurality of primary electrode active material particles and including a plurality of pores between the primary electrode active material particles.

### Aspect 3

The method according to Aspect 1 or 2, in which a value S_{AM}/S_{SE} is a value obtained by dividing the specific surface area of the porous electrode active material particles by the specific surface area of the solid electrolyte particles, satisfies 1<S_{AM}/S_{SE}≤10, and a value d_{AM}/d_{SE} is a value obtained by dividing the average particle diameter of the porous electrode active material particles by the average particle diameter of the solid electrolyte particles, satisfies 50≤d_{AM}/d_{SE}≤200, either or both of these relationships being satisfied.

### Aspect 4

The method according to any one of Aspects 1 to 3, in which the specific surface area of the porous electrode active material particles is 50 m²/g to 300 m²/g, and the specific surface area of the solid electrolyte particles is 10 m²/g to 100 m²/g, and the average particle diameter of the porous electrode active material particles is 1 μm to 20 μm, and the average particle diameter of the solid electrolyte particles is 0.01 μm to 1 μm, either or both of these relationships being satisfied.

### Aspect 5

A method of producing an electrode active material layer, the method comprising the following steps: a step of producing the electrode mixed material slurry by the method according to any one of Aspects 1 to 4; and a step of applying the electrode mixed material slurry to a base material and drying and removing the solvent.

According to the method of the present disclosure for producing an electrode mixed material slurry, it is possible to provide an electrode mixed material slurry capable of improving the ion conductivity of an electrode active material layer.

According to the method of the present disclosure for producing an electrode active material layer, it is possible to provide an electrode active material layer having improved ion conductivity.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is an image of the electrode mixed material slurry of Comparative Example 1, in a state of being stretched on a grind gauge;

FIG. 1B is an image of the electrode mixed material slurry of Embodiment 1, in a state of being stretched on a grind gauge;

FIG. 1C is an image of the electrode mixed material slurry of Comparative Example 2, in a state of being stretched on a grind gauge; and

FIG. 2 is a graph showing ion conductivities of the electrode active material layers of Embodiment 1 and Comparative Examples 1 and 2.

### DETAILED DESCRIPTION OF EMBODIMENTS

Hereinafter, an embodiment of the present disclosure will be described in detail. The present disclosure is not limited to the following embodiments, and can be variously modified and implemented within the spirit of the disclosure.

### Method of Producing Electrode Mixed Material Slurry

A method of producing an electrode mixed material slurry according to the present disclosure includes the following steps: a step of preparing a solid electrolyte slurry by mixing solid electrolyte particles, a dispersant, and a solvent; and a step of mixing porous electrode active material particles with the solid electrolyte slurry.

In the method of the present disclosure, the following relational expressions (1) and (2) are satisfied: a specific surface area of the porous electrode active material particles>a specific surface area of the solid electrolyte particles . . . (1); and an average particle diameter of the porous electrode active material particles>an average particle diameter of the solid electrolyte particles . . . (2).

In the related art, it has been considered that particles having a large specific surface area are less likely to be dispersed in a solvent than particles having a small specific surface area. Based on such an estimation, it is considered that it is desirable to first disperse particles having a large specific surface area in a solvent together with a dispersant to prepare a slurry, and then disperse particles having a small specific surface area in the obtained slurry.

On the other hand, the present inventors have found that, unexpectedly, in a case where the average particle diameter and the specific surface area of the particles are both smaller, as in the solid electrolyte particles of the present disclosure, it is desirable to first disperse the particles in a solvent together with a dispersant to prepare an intermediate slurry (solid electrolyte slurry). The present inventors have found that, by dispersing particles having both a larger average particle diameter and a larger specific surface area, such as the porous electrode active material particles of the present disclosure, in the obtained intermediate slurry, the dispersibility of both particles in the slurry can be improved.

As a reason for this, it is not intended to be bound by any theory, but it is estimated as follows. That is, it is considered that particles having a relatively large average particle diameter are less likely to aggregate even in a case of having a large specific surface area, and thus have a certain dispersibility. Therefore, the present inventors consider that, first, by mixing particles having both a smaller average particle diameter and a smaller specific surface area, such as the solid electrolyte particles of the present disclosure, a dispersant, and a solvent, the dispersant can be spread on the surface of the particles. Accordingly, the present inventors consider that an intermediate slurry (solid electrolyte slurry) having improved dispersibility of the particles can be prepared. The present inventors consider that, in the intermediate slurry obtained in this way, particles having both a larger average particle diameter and a larger specific surface area, such as the porous electrode active material particles of the present disclosure, can be dispersed. As a result, the present inventors consider that a final slurry (electrode mixed material slurry) having improved dispersibility of both particles can be obtained. It is considered that, in the electrode active material layer produced from such an electrode mixed material slurry, the aggregation of each of the particles is small, and thus the electrode active material layer has improved ion conductivity.

In the present disclosure, the term “electrode mixed material” means a composition that can constitute an electrode active material layer as it is or by further containing other components. In addition, in the present disclosure, the term “electrode mixed material slurry” means a slurry that contains a dispersion medium in addition to the “electrode mixed material” and can form an electrode active material layer by being applied and dried.

In the present disclosure, the “electrode mixed material” may be a “positive electrode mixed material” or a “negative electrode mixed material”, and may be particularly a “negative electrode mixed material”.

Hereinafter, the method of the present disclosure for producing an electrode mixed material slurry will be described in more detail.

### Preparation of Solid Electrolyte Slurry

The method of the present disclosure includes a step of preparing a solid electrolyte slurry by mixing solid electrolyte particles, a dispersant, and a solvent.

A method of mixing the solid electrolyte particles, the dispersant, and the solvent is not particularly limited, and examples thereof include dispersion mixing using ultrasonic waves.

In this step, the components other than those described above may or may not be further mixed. Examples of such a component include a conductive auxiliary agent.

### Mixing of Porous Electrode Active Material Particles and Solid Electrolyte Slurry

The method of the present disclosure includes a step of mixing porous electrode active material particles and a solid electrolyte slurry.

A method of mixing the porous electrode active material particles and the solid electrolyte slurry is not particularly limited, and examples thereof include dispersion mixing using ultrasonic waves.

In this step, the components other than those described above may or may not be further mixed. Examples of such a component include a binder.

In the method of the present disclosure, the following relational expressions (1) and (2) are satisfied: a specific surface area of the porous electrode active material particles >a specific surface area of the solid electrolyte particles . . . (1); and an average particle diameter of the porous electrode active material particles>an average particle diameter of the solid electrolyte particles . . . (2).

In a case where the relational expressions (1) and (2) are satisfied, the present inventors consider that, by producing the electrode mixed material slurry in the above-described procedure, the dispersibility of both the solid electrolyte particles and the porous electrode active material particles in the slurry is improved. Therefore, the present inventors consider that it is possible to provide an electrode mixed material slurry capable of improving the ion conductivity of an electrode active material layer.

In the method of the present disclosure, the following may be satisfied: a value S_{AM}/S_{SE} of a specific surface area of the porous electrode active material particles/specific surface area of the solid electrolyte particles is 1<S_{AM}/S_{SE}≤10, 3≤S_{AM}/S_{SE}≤8, or 4≤S_{AM}/S_{SE}≤6, and a value d_{AM}/d_{SE} of an average particle diameter of the porous electrode active material particles/average particle diameter of the solid electrolyte particles is 50≤d_{AM}/d_{SE}≤200, 70≤d_{AM}/d_{SE}≤150, or 80≤d_{AM}/d_{SE}≤120, either or both of these relationships being satisfied.

S_{AM}/S_{SE} may be more than 1, 2 or more, 3 or more, 4 or more, or 5 or more, and may be 10 or less, 9 or less, 8 or less, 7 or less, 6 or less, or 5 or less.

d_{AM}/d_{SE} may be 50 or more, 60 or more, 70 or more, 80 or more, 90 or more, or 100 or more, and may be 200 or less, 170 or less, 150 or less, 130 or less, 120 or less, 110 or less, or 100 or less.

By the S_{AM}/S_{SE} and/or d_{AM}/d_{SE} being within the above-described ranges, it is possible to provide an electrode mixed material slurry capable of effectively improving the ion conductivity of the electrode active material layer.

In the method of the present disclosure, it is considered that: the specific surface area S_{AM} of the porous electrode active material particles may be 50 m²/g to 300 m²/g, 100 m²/g to 200 m²/g, or 130 m²/g to 170 m²/g, and the specific surface area S_{SE} of the solid electrolyte particles may be 10 m²/g to 100 m²/g, 15 m²/g to 70 m²/g, or 20 m²/g to 50 m²/g, and the average particle diameter d_{AM} of the porous electrode active material particles may be 1 μm to 20 μm, 3 μm to 17 μm, or 5 μm to 15 μm, either or both of these relationships being satisfied. It is considered that the average particle diameter d_{SE} of the solid electrolyte particles may be 0.01 μm to 1 μm, 0.03 μm to 0.7 μm, or 0.05 μm to 0.5 μm.

S_{AM} may be 50 m²/g or more, 80 m²/g or more, 100 m²/g or more, 120 m²/g or more, 130 m²/g or more, 140 m²/g or more, or 150 m²/g or more. In addition, S_{AM} may be 300 m²/g or less, 250 m²/g or less, 200 m²/g or less, 180 m²/g or less, 170 m²/g or less, 160 m²/g or less, or 150 m²/g or less.

S_{SE} may be 10 m²/g or more, 15 m²/g or more, 20 m²/g or more, 25 m²/g or more, or 30 m²/g or more. In addition, S_{SE} may be 100 m²/g or less, 70 m²/g or less, 50 m²/g or less, 40 m²/g or less, or 30 m²/g or less.

d_{AM} may be 1 μm or more, 3 μm or more, 5 μm or more, 7 μm or more, 8 μm or more, 9 μm or more, or 10 μm or more, and may be 20 μm or less, 17 μm or less, 15 μm or less, 13 μm or less, 12 μm or less, 11 μm or less, or 10 μm or less. d_{AM} may be 1 μm or more, 3 μm or more, 5 μm or more, 7 μm or more, 8 μm or more, 9 μm or more, or 10 μm or more. In addition, d_{AM} may be 20 μm or less, 17 μm or less, 15 μm or less, 13 μm or less, 12 μm or less, 11 μm or less, or 10 μm or less.

d_{SE} may be 0.01 μm or more, 0.03 μm or more, 0.05 μm or more, 0.07 μm or more, 0.08 μm or more, 0.09 μm or more, or 0.1 μm or more, and may be 1 μm or less, 0.7 μm or less, 0.5 μm or less, 0.3 μm or less, 0.2 μm or less, or 0.1 μm or less. d_{SE} may be 0.01 μm or more, 0.03 μm or more, 0.05 μm or more, 0.07 μm or more, 0.08 μm or more, 0.09 μm or more, or 0.1 μm or more. In addition, d_{SE} may be 1 μm or less, 0.7 μm or less, 0.5 μm or less, 0.3 μm or less, 0.2 μm or less, or 0.1 μm or less.

By the S_{AM} and S_{SE}, and/or d_{AM} and d_{SE} being within the above-described ranges, it is possible to provide an electrode mixed material slurry capable of effectively improving the ion conductivity of the electrode active material layer.

The average particle diameter can be determined by observation with an electron microscope such as a scanning electron microscope (SEM), and is determined, for example, as an average value of the maximum Feret diameters of a plurality of particles. The number of samples is preferably large, and may be, for example, 20 or more, 50 or more, or 100 or more.

The specific surface area can be measured by performing measurement of a sample by a nitrogen adsorption method using a specific surface area and pore distribution measuring device, and by the BET method.

Hereinafter, materials that can be used in the method of the present disclosure will be described.

### Solid Electrolyte Particles

The solid electrolyte particles are not particularly limited as long as the above-described relational expressions (1) and (2) are satisfied in relation to the porous electrode active material particles.

Examples of the solid electrolyte particles include particles of an inorganic solid electrolyte such as a sulfide solid electrolyte, an oxide solid electrolyte, a nitride solid electrolyte, and a halide solid electrolyte, and particles of an organic polymer electrolyte such as a polymer electrolyte. The solid electrolyte particles may be particularly sulfide solid electrolyte particles.

For example, in a case where the battery is a lithium ion secondary battery, the solid electrolyte particles may have lithium ion conductivity.

Examples of the sulfide solid electrolyte particles having lithium ion conductivity include Li elements and X elements (X is at least one of P, As, Sb, Si, Ge, Sn, B, Al, Ga, or In). Further, examples thereof include solid electrolyte particles containing an S element. In addition, the sulfide solid electrolyte particles may further contain at least one of an O element or a halogen element. Examples of the halogen element include F elements, Cl elements, Br elements, and I elements.

Examples of the sulfide solid electrolyte particles include Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, and Li₂S—P₂S₅—LiI—LiBr. In addition, examples thereof include Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, and Li₂S—P₂S₅—ZₘSₙ (m and n are positive numbers). Z is any one of Ge, Zn, or Ga, and examples thereof include particles of Li₂S—GeS₂, Li₂S—SiS₂—Li₃PO₄, and Li₂S—SiS₂—LiₓMO_{y} (where x and y are positive numbers and M is any one of P, Si, Ge, B, Al, Ga, or In).

Examples of the oxide solid electrolyte particles having lithium ion conductivity include Li elements and Y elements (Y is at least one of Nb, B, Al, Si, P, Ti, Zr, Mo, W, or S). Further, examples thereof include solid electrolyte particles containing an O element. Specific examples thereof include garnet-type solid electrolyte particles such as Li₇La₃Zr₂O₁₂, Li₇₋ₓLa₃(Zr₂₋ₓNbₓ)O₁₂ (0≤x≤2), and Li₅La₃Nb₂O₁₂; and perovskite-type solid electrolyte particles such as (Li, La)TiO₃, (Li, La)NbO₃, and (Li, Sr)(Ta, Zr)O₃. In addition, examples thereof include NASICON-type solid electrolyte particles such as Li(Al, Ti)(PO₄)₃ and Li(Al, Ga)(PO₄)₃; Li—P—O-based solid electrolyte particles such as Li₃PO₄ and LIPON (a compound in which a part of O in Li₃PO₄ is substituted with N); and Li—B—O-based solid electrolyte particles such as Li₃BO₃ and a compound in which a part of O in Li₃BO₃ is substituted with C.

The content of the solid electrolyte particles in the solid content of the solid electrolyte slurry and the electrode mixed material slurry is not particularly limited, and can be appropriately set in consideration of desired ion conductivity or the like.

### Dispersant

The dispersant is not particularly limited as long as it functions as a dispersant for the porous electrode active material particles and the solid electrolyte particles.

The content of the dispersant in the solid content of the solid electrolyte slurry and the electrode mixed material slurry is not particularly limited, and can be appropriately set in consideration of desired dispersibility or the like.

### Porous Electrode Active Material Particles

The porous electrode active material particles are not particularly limited as long as the above-described relational expressions (1) and (2) are satisfied in relation to the solid electrolyte particles.

In the present disclosure, the term “porous electrode active material particles” means particles having a plurality of fine pores. The “electrode active material” may be a “positive electrode active material” or a “negative electrode active material”, and may be particularly a “negative electrode active material”.

The porous electrode active material particles may be porous electrode active material primary particles having a plurality of fine pores inside primary particles.

In addition, the porous electrode active material particles may be electrode active material composite particles. Here, the electrode active material composite particles are secondary particles formed from a plurality of electrode active material primary particles and having a plurality of fine pores between the plurality of electrode active material primary particles. In this case, the average particle diameter of the porous electrode active material particles is easily increased, and thus the relational expression (2) is easily satisfied.

The electrode active material primary particles in the electrode active material composite particles may be porous electrode active material primary particles. That is, the “porous electrode active material particles” may have a plurality of fine pores inside the primary particles and a plurality of fine pores between the primary particles inside the secondary particles. In this case, both the specific surface area and the average particle diameter are easily increased, and thus the relational expressions (1) and (2) are easily satisfied.

The electrode active material may be silicon. That is, the porous electrode active material particles may be porous silicon electrode active material primary particles or silicon electrode active material composite particles formed of a plurality of silicon electrode active material primary particles. Silicon expands and contracts with the charging and discharging of the battery, and thereby the contact area between the silicon electrode active material particles and the solid electrolyte particles in the electrode active material layer may be reduced. This is because it is one of the causes of the decrease in ion conductivity, and thus the significance of applying the method of the present disclosure is high in a case where the electrode active material is silicon.

The composition of the silicon electrode active material primary particles is not particularly limited as long as it contains silicon. The proportion of silicon in all elements contained in the primary particles may be, for example, 50 mol % or more, 70 mol % or more, 90 mol % or more, 95 mol % or more, or 99 mol % or more. The primary particles may contain or may not contain elements other than silicon. Examples of the other elements include Sn, Fe, Co, Ni, Ti, Cr, B, and P, in addition to Li. The primary particles may contain an oxide of silicon.

The silicon electrode active material primary particles may be amorphous or crystalline. The crystal phase contained in the silicon is not particularly limited.

The porous silicon electrode active material primary particles may be porous silicon electrode active material primary particles obtained by making the above-described silicon electrode active material primary particles porous. As a method of making the silicon electrode active material primary particles porous, a normal method can be adopted.

In a case where the porous electrode active material particles are electrode active material composite particles, the electrode active material composite particles may further contain a binder. The binder can bind a plurality of electrode active material primary particles to each other, and thus it is possible to easily prepare the electrode active material composite particles.

The binder that may be contained in the electrode active material composite particles is not particularly limited. For example, a butadiene rubber (BR)-based binder, a butylene rubber (IIR)-based binder, an acrylate butadiene rubber (ABR)-based binder, a styrene butadiene rubber (SBR)-based binder, a polyvinylidene fluoride (PVdF)-based binder, a polytetrafluoroethylene (PTFE)-based binder, a polyimide (PI)-based binder, a carboxymethyl cellulose (CMC)-based binder, a polyacrylate-based binder, a polyacrylic acid ester-based binder, or a combination thereof may be used.

The content of the electrode active material primary particles in the electrode active material composite particles is not particularly limited, and can be appropriately set in consideration of desired battery capacity or the like.

The content of the binder in the electrode active material composite particles is not particularly limited, and can be appropriately set in consideration of desired binding properties or the like.

The electrode active material composite particles can be produced by a method including the following steps: providing a slurry containing electrode active material primary particles and a dispersion medium; and drying and removing the dispersion medium by spray drying.

The electrode active material primary particles can refer to the above description.

The dispersion medium is not particularly limited as long as it can disperse the electrode active material primary particles.

In a case where the electrode active material composite particles further contain a binder, the dispersion medium is not particularly limited as long as it can disperse the electrode active material primary particles and can dissolve or disperse the binder.

The binder can refer to the above description.

By adjusting the concentration of solid contents of the slurry, the liquid feeding amount of the slurry in the spray drying, the spraying pressure, the drying temperature, and the like, the average particle diameter of the electrode active material composite particles can be controlled.

The content of the porous electrode active material particles in the solid content of the electrode mixed material slurry is not particularly limited, and can be appropriately set in consideration of desired battery capacity or the like.

### Conductive Auxiliary Agent

The conductive auxiliary agent may be, for example, a carbon material, a metal particle, or a combination thereof. The carbon material may be, for example, the following combination. The carbon material may be a non-fibrous carbon material such as acetylene black (AB) or ketjen black (KB); a fibrous carbon material such as vapor grown carbon fiber (VGCF), carbon nanotube (CNT), or carbon nanofiber (CNF); or a combination thereof. The metal particle may be, for example, nickel, copper, iron, stainless steel, or a combination thereof.

The content of the conductive auxiliary agent in the solid content of the solid electrolyte slurry and the electrode mixed material slurry is not particularly limited, and can be appropriately set in consideration of desired conductivity or the like.

### Binder

The binder that may be contained in the electrode mixed material slurry may be, for example, the following combination: a rubber-based binder such as butadiene rubber, hydrogenated butadiene rubber, styrene-butadiene rubber (SBR), hydrogenated styrene-butadiene rubber, nitrile-butadiene rubber, hydrogenated nitrile-butadiene rubber, acrylate-butadiene rubber (ABR), and ethylene propylene rubber; a fluorine-based binder such as polyvinylidene fluoride (PVdF), a polyvinylidene fluoride-polyhexafluoropropylene copolymer (PVdF-HFP), polytetrafluoroethylene, and fluororubber; a thermoplastic resin of a polyolefin-based resin such as polyethylene, polypropylene, and polystyrene; an imide-based resin such as polyimide and polyamideimide; an amide-based resin such as polyamide; an acrylic-based resin such as polymethyl acrylate and polyethyl acrylate; a methacrylic-based resin such as polymethyl methacrylate and polyethyl methacrylate; or a combination thereof.

The content of the binder in the solid content of the electrode mixed material slurry is not particularly limited, and can be appropriately set in consideration of desired binding properties or the like.

### Solvent

The solvent is not particularly limited as long as it can disperse the porous electrode active material particles and the solid electrolyte particles. In a case where the electrode mixed material slurry further contains a conductive auxiliary agent and a binder, the solvent may be able to disperse the conductive auxiliary agent and dissolve or disperse the binder. Examples of such a dispersion medium include tetralin.

### Method of Producing Electrode Active Material Layer

A method of producing an electrode active material layer according to the present disclosure includes the following steps: producing an electrode mixed material slurry by the method of the present disclosure; and applying the electrode mixed material slurry to a base material and drying and removing the solvent. As a result, it is possible to provide an electrode active material layer having improved ion conductivity.

In the present disclosure, the term “electrode active material layer” may be a “positive electrode active material layer” or a “negative electrode active material layer”, and may be particularly a “negative electrode active material layer”.

### Production of Electrode Mixed Material Slurry

The method of the present disclosure includes producing an electrode mixed material slurry by the method of the present disclosure. The method of the present disclosure for producing an electrode mixed material slurry can refer to the above description.

### Drying and Removing of Solvent

The method of the present disclosure includes applying the electrode mixed material slurry to a base material and drying and removing the solvent.

A method of applying the electrode mixed material slurry is not particularly limited, and a normal method can be adopted.

The base material to which the electrode mixed material slurry is applied is not particularly limited, and may be, for example, a collector layer or a peeling sheet. The collector layer can refer to the description of the negative electrode laminated layer and the positive electrode collector layer described later.

A method of drying and removing the dispersion medium is not particularly limited, and a normal method can be adopted.

### Manufacturing Method of Battery

A battery can be produced by a method including producing an electrode active material layer by the method of the present disclosure.

The electrode active material layer of the battery obtained in this way has improved ion conductivity.

The method of the present disclosure for producing an electrode active material layer can refer to the above description.

A method of producing a battery may further include laminating the electrode active material layer and each of layers described later that can constitute a battery to form an electrode laminated body.

Other members such as a terminal are attached to the electrode laminated body as necessary. A battery can be obtained by accommodating and sealing the electrode laminated body in a battery case.

### Battery

The battery has an electrode active material layer produced by the method of the present disclosure. The battery may have a negative electrode collector layer, a negative electrode active material layer, an electrolyte layer, a positive electrode active material layer, and a positive electrode collector layer in this order. In the battery, the negative electrode active material layer or the positive electrode active material layer may be an electrode active material layer produced by the method of the present disclosure, and, in particular, the negative electrode active material layer may be an electrode active material layer produced by the method of the present disclosure.

The battery according to the present disclosure may be a liquid battery or a solid battery, and may be particularly a solid battery. In the present disclosure, the term “solid battery” means a battery including at least a solid electrolyte as an electrolyte, and thus the solid battery may include a combination of a solid electrolyte and a liquid electrolyte as an electrolyte. In addition, the solid battery may be an all-solid state battery, that is, a battery including only a solid electrolyte as an electrolyte.

The battery may be a primary battery or a secondary battery, and may be particularly a lithium ion secondary battery.

The battery may be restrained by a restraint member such as an end plate from both sides in the lamination direction of each of the layers. Examples of the restraint method include a method of using a bolt tightening torque, but the restraint method is not limited thereto.

Hereinafter, each element that can constitute the battery will be described. Hereinafter, an example will be described in a case where the battery is an all-solid state battery and the electrode active material layer produced by the method of the present disclosure is a negative electrode active material layer.

### Negative Electrode Collector Layer

The negative electrode collector layer may be a foil shape, a plate shape, a mesh shape, a punched metal shape, or a foaming body. The negative electrode collector layer may be a metal foil or a metal mesh, and may be a carbon sheet, and may be particularly a metal foil. The negative electrode collector layer may be formed of a plurality of foils or sheets.

The metal constituting the negative electrode collector layer is not particularly limited, and examples thereof include copper, nickel, chromium, gold, platinum, silver, aluminum, iron, titanium, zinc, cobalt, and stainless steel. In particular, the negative electrode collector layer may include at least one metal selected from copper, nickel, or stainless steel.

A coating layer may be formed on the surface of the negative electrode collector layer for the purpose of adjusting the resistance or the like. In addition, the negative electrode collector layer may be a metal foil or a base material on which the above-described metal is plated or vapor-deposited. In addition, in a case where the negative electrode collector layer consists of a plurality of metal foils, a certain layer may be provided between the plurality of metal foils.

A thickness of the negative electrode collector layer is not particularly limited, and may be, for example, 0.1 μm or more or 1 μm or more, and may be 1 mm or less or 100 μm or less.

### Negative Electrode Active Material Layer

In the above-described aspect, the negative electrode active material layer is an electrode active material layer produced by the method of the present disclosure. The method of the present disclosure for producing an electrode active material layer can refer to the above description.

### Solid Electrolyte Layer

The solid electrolyte layer includes solid electrolyte particles and may optionally further include a binder.

The solid electrolyte particles and the binder can refer to the above description.

A thickness of the solid electrolyte layer is not particularly limited, and may be, for example, 0.1 μm or more and 1,000 μm or less.

### Positive Electrode Active Material Layer

The positive electrode active material layer includes a positive electrode active material and may optionally further include a solid electrolyte, a conductive auxiliary agent, and a binder.

The positive electrode active material is not particularly limited, and may be, for example, an oxide active material. The oxide active material used in the lithium ion battery may be, for example, LiCoO₂, LiMnO₂, Li₂NiMn₃O₈, LiVO₂, or LiCrO₂. In addition, the positive electrode active material may be LiFePO₄, LiCoPO₄, LiNiO₂, or LiNi_{1/3}Co_{1/3}Mn_{1/3}O₂. In addition, a coating layer containing a Li ion-conductive oxide such as LiNbO₃ may be formed on the surface of these active materials.

A content of the positive electrode active material in the positive electrode active material layer is not particularly limited, and can be appropriately set in consideration of desired battery capacity or the like.

The solid electrolyte, the conductive auxiliary agent, and the binder can refer to the above description.

A thickness of the positive electrode active material layer is not particularly limited, and may be, for example, 0.1 μm or more and 1,000 μm or less.

### Positive Electrode Collector Layer

The positive electrode collector layer may be a foil shape, a plate shape, a mesh shape, a punched metal shape, or a foaming body. The positive electrode collector layer may be a metal foil or a metal mesh, and may be particularly a metal foil. The positive electrode collector layer may consist of a plurality of foils.

Examples of the metal constituting the positive electrode collector layer include copper, nickel, chromium, gold, platinum, silver, aluminum, iron, titanium, zinc, cobalt, and stainless steel, and the positive electrode collector layer may include aluminum in particular.

A coating layer may be formed on the surface of the positive electrode collector layer for the purpose of adjusting the resistance or the like. In addition, the positive electrode collector layer may be a metal foil or a base material on which the above-described metal is plated or vapor-deposited. In addition, in a case where the positive electrode collector layer consists of a plurality of metal foils, a certain layer may be provided between the plurality of metal foils.

A thickness of the positive electrode collector layer is not particularly limited, and may be, for example, 0.1 μm or more or 1 μm or more, and may be 1 mm or less or 100 μm or less.

### Other Configurations

The battery may be configured such that each of the above-described configurations is accommodated inside an exterior body. As the exterior body, any of known exterior bodies for batteries can be adopted. In addition, a plurality of the batteries may be electrically connected and optionally stacked, thereby forming an assembled battery. In this case, the assembled battery may be accommodated in a known battery case. The battery may have an obvious configuration such as a necessary terminal. A shape of the battery may be, for example, a coin shape, a laminated (pouch) shape, a cylindrical shape, or a rectangular shape.

### Example 1

### Manufacture of Electrode Active Material Layer

### Preparation of Solid Electrolyte Slurry

700 mg of LPS glass ceramics (average particle diameter: 0.1 μm, specific surface area: 30 m²/g) as sulfide solid electrolyte particles was added to 4 g of tetralin as a solvent. Further, 3 mg of single-walled CNT (width: 3 nm, diameter: 5 μm, specific surface area: 1,000 m²/g) as a conductive auxiliary agent and a predetermined amount of a dispersant were added thereto, and the mixture was dispersed and mixed with ultrasonic waves for 2 minutes. As a result, a solid electrolyte slurry was obtained.

### Mixing of Porous Electrode Active Material Particles and Solid Electrolyte Slurry

700 mg of silicon electrode active material composite particles (average particle diameter: 10 μm, specific surface area: 150 m²/g) as porous electrode active material particles was added to the obtained solid electrolyte slurry. Further, 600 mg of a 5% by mass styrene-butadiene rubber (SBR) tetralin solution as a binder was added thereto, and the mixture was dispersed and mixed with ultrasonic waves for 10 minutes. As a result, an electrode mixed material slurry was obtained. The obtained electrode mixed material slurry was applied onto a nickel (Ni) foil as a peeling sheet at a gap of 300 μm to obtain a coating layer. The obtained coating layer was dried at 180 °C for 2 hours. The dried coating layer was punched into a size of φ11.28 mm and pressed at a surface pressure of 5 t/cm² to be densified, thereby producing an electrode active material layer of Example 1.

### Comparative Example 1

An electrode active material layer of Comparative Example 1 was obtained in the same manner as in Example 1, except that the timing of adding the solid electrolyte particles and the silicon electrode active material composite particles was reversed.

### Comparative Example 2

An electrode active material layer of Comparative Example 2 was obtained in the same manner as in Example 1, except that all the solid contents were added at the same timing and the time of the dispersion mixing with ultrasonic waves was set to the total time of the dispersion mixing with ultrasonic waves in Example 1.

### Evaluation

### Particle Size of Particles in Slurry

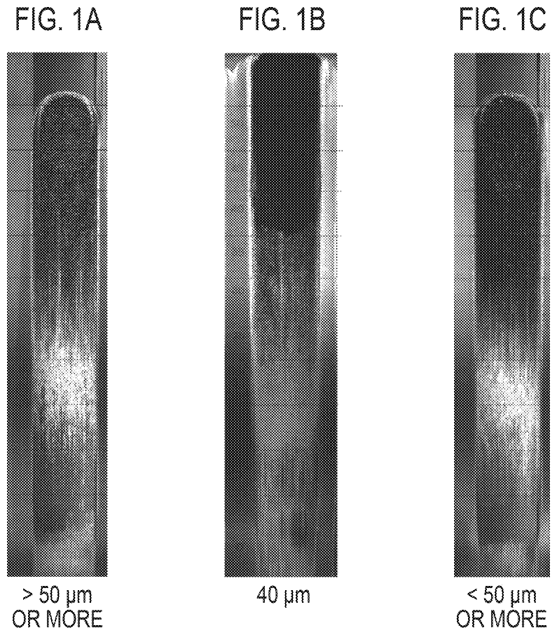

The electrode mixed material slurries of each of Examples were stretched on a grind gauge. Each of the electrode mixed material slurries in this state was imaged using a grind gauge scanner (AGS-100, manufactured by Asahi Soken Co., Ltd.). The captured images are shown in FIGS. 1A to 1C (FIG. 1A: Comparative Example 1, FIG. 1B: Example 1, FIG. 1C: Comparative Example 2). From these images, the particle size of the slurry was determined according to the method of JIS K 5600-2-5. As shown in FIGS. 1A to 1C, the grind gauge of Example 1 was 40 μm, and the grind gauges of Comparative Examples 1 and 2 were 50 μm or more. This indicates that, in the electrode mixed material slurry of Example 1 produced by the method of the present disclosure, the coarse particles due to aggregation were small and the dispersibility of the particles was good.

### Ion Conductivity

### Production of Reference Cell

200 mg of solid electrolyte particles was put into a ceramic cylinder having a hole of a size of φ11.28, and the cylinder was pressed at a surface pressure of 5 t/cm² to be densified, thereby producing a solid electrolyte layer. A thickness of the obtained solid electrolyte layer was measured.

A lithium foil was laminated on both surfaces of the solid electrolyte layer, and a pin made of SUS was inserted from the upper and lower sides of the cylinder, and the cylinder was restrained at 20 MPa. As a result, a reference cell was obtained. For the obtained reference cell, a polarization resistance was measured by a direct current polarization method.

### Production of Evaluation Cell

100 mg of solid electrolyte particles was put into a ceramic cylinder having a size of φ11.28, and the cylinder was pressed at a surface pressure of 5 t/cm² to be densified, thereby producing a first solid electrolyte layer.

Each of the electrode active material layers peeled off from the Ni foil was laminated on the obtained first solid electrolyte layer. 100 mg of a solid electrolyte was put on the electrode active material layer, and the mixture was pressed at a surface pressure of 5 t/cm² to be densified, thereby obtaining an electrode laminated body having a first solid electrolyte layer, the electrode active material layer, and a second solid electrolyte layer in this order. A thickness of the obtained electrode laminated body was measured.

A lithium foil was laminated on each of the solid electrolyte layers laminated on both surfaces of the electrode active material layer, and a pin made of SUS was inserted from the upper and lower sides of the cylinder, and the cylinder was restrained at 20 MPa. As a result, an evaluation cell was obtained. For the obtained evaluation cell, a polarization resistance was measured by a direct current polarization method.

### Calculation of Ion Conductivity

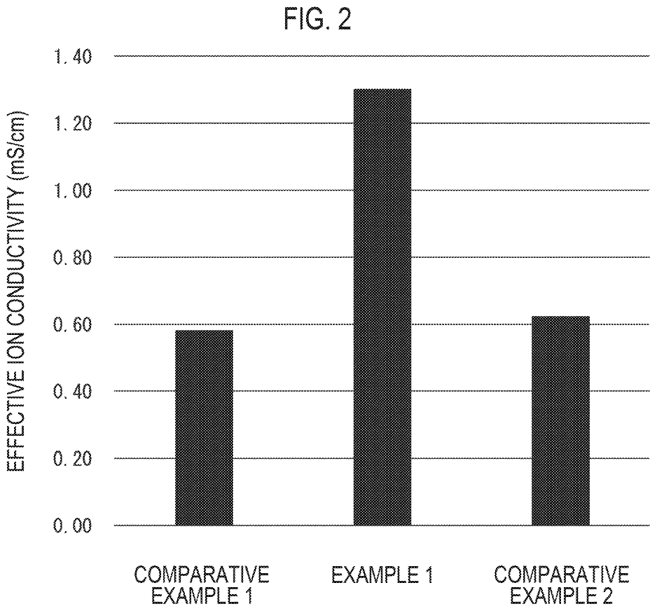

A polarization resistance R of the electrode active material layer was obtained from a difference in polarization resistance between the evaluation cell and the reference cell. In addition, a thickness L of the electrode active material layer was obtained from a difference in thickness between the evaluation cell and the reference cell. An ion conductivity of the electrode active material layer was obtained from an expression σ=L/(S·R) in which an area of the electrode active material layer was S and the ion conductivity was σ. The results are shown in FIG. 2.

As shown in FIG. 2, in the electrode active material layer of Example 1 produced by the method of the present disclosure, the ion conductivity was large.

What is claimed is:

1. A method of producing an electrode mixed material slurry, the method comprising the following steps:
a step of mixing solid electrolyte particles, a dispersant, and a solvent to prepare a solid electrolyte slurry; and
a step of mixing porous electrode active material particles with the solid electrolyte slurry, wherein
the following relational expressions (1) and (2) are satisfied:
(1) a specific surface area of the porous electrode active material particles>a specific surface area of the solid electrolyte particles; and
(2) an average particle diameter of the porous electrode active material particles>an average particle diameter of the solid electrolyte particles.

2. The method according to claim 1, wherein:
the porous electrode active material particles are electrode active material composite particles; and
the electrode active material composite particles are secondary particles made of a plurality of primary electrode active material particles and including a plurality of pores between the primary electrode active material particles.

3. The method according to claim 2, wherein:
a value S_{AM}/S_{SE} is a value obtained by dividing the specific surface area of the porous electrode active material particles by the specific surface area of the solid electrolyte particles, satisfies 1<S_{AM}/S_{SE}≤10; and
a value d_{AM}/d_{SE} is a value obtained by dividing the average particle diameter of the porous electrode active material particles by the average particle diameter of the solid electrolyte particles, satisfies 50≤d_{AM}/d_{SE}≤200, either or both of these relationships being satisfied.

4. The method according to claim 3, wherein:
the specific surface area of the porous electrode active material particles is 50 m²/g to 300 m²/g, and the specific surface area of the solid electrolyte particles is 10 m²/g to 100 m²/g; and
the average particle diameter of the porous electrode active material particles is 1 μm to 20 μm, and the average particle diameter of the solid electrolyte particles is 0.01 μm to 1 μm, either or both of these relationships being satisfied.

5. A method of producing an electrode active material layer, the method comprising the following steps:
a step of producing the electrode mixed material slurry by the method according to claim 1; and
a step of applying the electrode mixed material slurry to a base material and drying and removing the solvent.
